(19) United States
(12) Patent Application Publication
(10) Pub. No.: US 2013/0163595 A1
(43) Pub. Date: Jun. 27, 2013

(54) PACKET CLASSIFICATION APPARATUS AND METHOD FOR CLASSIFYING PACKET THEREOF

(71) Applicants: Kyeong Hwan DOO, Daejeon (KR); Jung Hee LEE, Daejeon (KR); Kang Il CHOI, Daejeon (KR); Bhum Cheol LEE, Daejeon (KR)

(72) Inventors: Kyeong Hwan DOO, Daejeon (KR); Jung Hee LEE, Daejeon (KR); Kang Il CHOI, Daejeon (KR); Bhum Cheol LEE, Daejeon (KR)

(73) Assignee: Electronics and Telecommunications Research Institute, Daejeon (KR)

(21) Appl. No.: 13/613,978

(22) Filed: Sep. 13, 2012

(30) Foreign Application Priority Data
Dec. 23, 2011 (KR) 10-2011-0141297

(51) Int. Cl. H04L 12/56

(52) U.S. Cl. 370/392

(57) ABSTRACT

Disclosed is a packet processing device which includes a packet processor Classifying a packet according to a region needed to search and providing a search key corresponding to the classified packet; a search key distributing unit decoding the search key to classify an address-based search key and a content-based search key; an address-based content addressable memory (hereinafter, referred to as CAM) unit performing an address-based search operation according to the address-based search key; a content-based CAM unit performing a content-based search operation according to the content-based search key; and a packet forwarding unit processing an output toward a port corresponding to a packet transferred from the packet processor, based on results searched according to the address-based search operation and the content-based search operation.

### CROSS-REFERENCE TO RELATED APPLICATIONS

A claim for priority under 35 U.S.C. §119 is made to Korean Patent Application No. 10-2011-0141297 filed Dec. 23, 2011, in the Korean Intellectual Property Office, the entire contents of which are hereby incorporated by reference.

### BACKGROUND

The inventive concepts described herein relate to a communication system, and more particularly, relate to device and method Classifying packets at a communication system using packets.

As a conventional communication system is merged into a broadcasting system, a network may become complicated. Also, a new communication service requiring a wider band may continue to appear. This may make the amount of traffic on a communication system rapidly increase.

As demand of a user increases, a communication system may classify various service packets and secure the quality and service required by each user. Network devices such as switches and routers processing packets may evolve into a customized processing manner, not a batch processing manner using an address domain of an internet protocol packet. With the customized processing manner, packet classification may be departmentalized with respect to respective packets. To provide a customized processing service departmentalized according to a packet, network devices may analyze a packet attribute to process a packet by differentially Classifying packets. To classify packets, network devices may use packet contents as well as a packet header. Network devices may classify packets rapidly by performing rapid lookup on a packet. Also, network devices may include content addressable memory (hereinafter, referred to as CAM) and ternary content addressable memory (hereinafter, referred to as TCAM) to perform a high-speed lookup function on many data patterns.

The TCAM may be used to store an internet protocol lookup and a routing table for an internet protocol address search at a high-speed router or a 3-layer switch being a hardware solution for packet classification. The CAM may use two search words (e.g., ‘0’ and ‘1’), and the TCAM may use three search words (e.g., ‘0’, ‘ 1’, ‘’'' (indicting don't care)). That is, the TCAM may be formed of a multiple cell capable of storing one of three logic states 0, 1, and *.

Network devices may classify packets using the CAM or TCAM. The CAM or TCAM may be formed of a static random access memory (SRAM). Thus, in network devices Classifying packets using a CAM or a TCAM, a size of a memory included in the CAM or TCAM may increase in proportion to an increase in a packet size. However, the CAM or TCAM may have a problem that a processing speed and a capacity are limited due to a limited process technique. Thus, it is difficult to improve a packet processing speed and a packet processing flexibility of a conventional network device.

### SUMMARY

One aspect of embodiments of the inventive concept is directed to provide a packet processing device comprising a packet processor Classifying a packet according to a region needed to search and providing a search key corresponding to the classified packet; a search key distributing unit decoding the search key to classify an address-based search key and a content-based search key; an address-based content addressable memory (hereinafter, referred to as CAM) unit performing an address-based search operation according to the address-based search key; a content-based CAM unit performing a content-based search operation according to the content-based search key; and a packet forwarding unit processing an output toward a port corresponding to a packet transferred from the packet processor, based on results searched according to the address-based search operation and the content-based search operation.

In example embodiments, the packet processor manages a lookup table for providing a search key associated with the packet.

In example embodiments, the lookup table includes information about a search key for Classifying an address-based packet, a content-based packet, and an address and content-based packet.

In example embodiments, the search key distributing unit outputs a search key for Classifying the address-based packet to the address-based CAM unit, outputs a search key for Classifying the content-based packet to the content-based CAM unit, and simultaneously outputs a search key for Classifying the address and content-based packet to the address-based CAM unit and the content-based CAM unit.

In example embodiments, the packet processor performs a matching operation about an address region of the packet based on a stored mask bit region.

In example embodiments, the packet processor provides the packet forwarding unit with a packet matched with the mask bit region.

In example embodiments, the packet forwarding unit forwards a packet transferred from the packet processor.

In example embodiments, the address-based CAM unit includes a plurality of address-based content addressable memories for parallel search processing.

In example embodiments, sizes and search key bit lengths of the plurality of address-based content addressable memories are set to be different.

In example embodiments, the plurality of address-based content addressable memories process classified address regions of a packet, respectively.

In example embodiments, the contents-based CAM unit includes a plurality of content-based content addressable memories for parallel search processing.

In example embodiments, sizes and search key bit lengths of the plurality of content-based content addressable memories are set to be different.

In example embodiments, the packet forwarding unit discards the packet when a discard of the packet is needed and revises information of the packet when a revision of the packet is needed.

Another aspect of embodiments of the inventive concept is directed to provide a method of processing a packet comprising Classifying a packet according to a region needed to search; distributing an address-based search key and a content-based search key through decoding of a search key corresponding to the classified packet; performing search operations on the address-based search key and the content-based search key in parallel; and outputting the packet according to the search result to be forwarded to a corresponding port.

In example embodiments, the Classifying a packet according to a region needed to search is performed using a lookup table including information about a search key for Classifying an address-based packet, a content-based packet, and an address and content-based packet.

In example embodiments, the performing search operations on the address-based search key and the content-based search key in parallel comprises performing a search operation about an address-based search key for Classifying the address-based packet; performing a search operation about an content-based search key for Classifying the content-based packet; and simultaneously performing a search operation about an address-based search key for Classifying the address-based packet and a search operation about an content-based search key for Classifying the content-based packet.

In example embodiments, the performing search operations on the address-based search key and the content-based search key in parallel comprises performing search operations of the distributed address-based search keys in parallel; and performing search operations of the distributed content-based search keys in parallel.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a packet processing device according to an embodiment of the inventive concept,

FIG. 2 is a block diagram schematically illustrating an address-based CAM unit according to an embodiment of the inventive concept, and

FIG. 3 is a block diagram schematically illustrating a content-based CAM unit according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

A packet processing device of the inventive concept may be applied to a communication system or a computer system. For example, the packet processing device of the inventive concept may be applied to a network device of a communication system such as a router, a switch, and the like. However, the inventive concept is applicable to other network devices to process packets in a high speed.

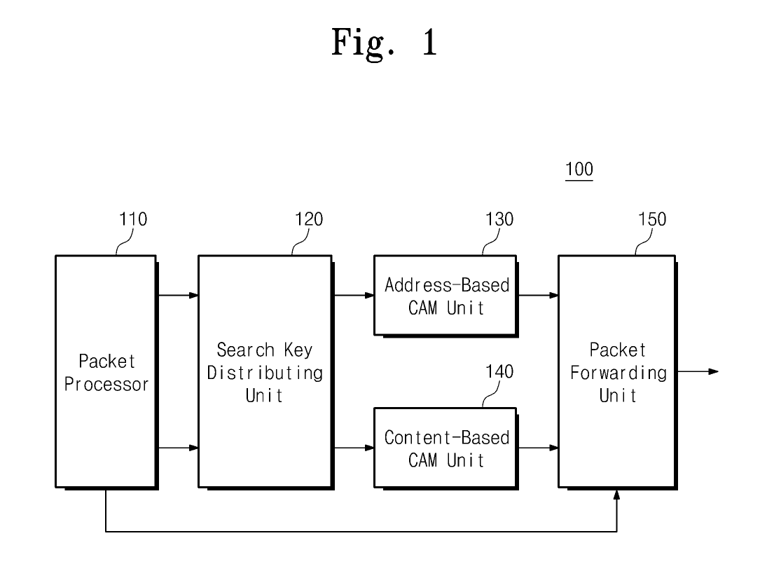

FIG. 1 is a block diagram schematically illustrating a packet processing device according to an embodiment of the inventive concept.

Referring to FIG. 1, a packet processing device 100 may include a packet processor 110, a search key distributing unit 120, an address-based CAM unit 130, a content-based CAM 140 unit, and a packet forwarding unit 150.

The packet processor 110 may be a pre-processing block that classifies a packet according a region needed for searching to classify an input packet in detail. The packet processor 110 may classify a packet according a region needed for searching, and may provide a corresponding search key to the classified packet. The packet processor 110 can divide a packet according to a search region. For example, when a search region corresponds to a header address of a packet, the packet processor 110 may classify the packet into an address-based packet. When a search region corresponds to a content of a packet, the packet processor 110 may classify the packet into a content-based packet. When a search region corresponds to header address and content of a packet, the packet processor 110 may classify the packet into an address-based packet and a content-based packet

A pre-processing lookup manner for Classifying a packet can be implemented by manners different from the above-described manner. Also, a lookup manner of the packet processor 110 may be implemented by a hash function using a processor or a memory. The lookup manner of the packet processor 110 may be implemented using a TCAM easy to manage a routing table.

The packet processor 110 may manage a lookup table by deleting, adding, and updating the lookup table periodically. With the above-described lookup manner, the lookup table may include information about a search key for Classifying a packet into an address-based packet, a content-based packet, and an address and content-based packet. The packet processor 110 may provide a search key corresponding to a classification reference needed according to a packet using a lookup table.

The packet processor 110 may store information associated with a mask bit region, and may match a partial address region of a packet using information associated with the mask bit region. At this time, the packet processor 110 may output a packet matched with the mask bit region directly to the packet forwarding unit 150 without passing through the address-based CAM unit 130 and the content-based CAM unit 140.

The search key distributing unit 120 may decode a search key to classify an address-based search key and a content-based search key. The search key distributing unit 120 may output a search key for Classifying an address-based packet to the address-based CAM unit 130. The search key distributing unit 120 may output a search key for Classifying a content-based packet to the content-based CAM unit 140. The search key distributing unit 120 may output a search key for Classifying an address and content-based packet to the address-based CAM unit 130 and the content-based CAM unit 140.

The search key distributing unit 120 may provide a search key decoding function when each of the address-based CAM unit 130 and the content-based CAM unit 140 includes a plurality of CAMs. The search key distributing unit 120 may be provided with information an update of the packet processor 110. For example, the search key distributing unit 120 may be provided with updated lookup table information from the packet processor 110.

The address-based CAM unit 130 may perform an address-based search operation according to an address-based search key. The address-based CAM unit 130 may include at least one address-based content addressable memory. The address-based CAM unit 130 may perform a search operation according to an input search key to output a search result to the packet forwarding unit 150. At this time, the address-based CAM unit 130 can output the search result to the packet processor 110 for packet processing.

The content-based CAM unit 140 may perform a content-based search operation according to a content-based search key. The content-based CAM unit 140 may include at least one content-based content addressable memory. The content-based CAM unit 140 may perform a search operation according to an input search key to output a search result to the packet forwarding unit 150. At this time, the content-based CAM unit 140 can output the search result to the packet processor 110 for packet processing.

A packet address searching operation of the address-based CAM unit 130 and a packet content searching operation of the content-based CAM unit 140 may be performed in parallel. Also, each of the address-based CAM unit 130 and the content-based CAM unit 140 may include a plurality of CAMs to search a plurality of search keys at the same time.

Each of the address-based CAM unit 130 and the content-based CAM unit 140 may be formed of a CAM or a TCAM.

The packet forwarding unit 150 may process an output toward a port corresponding to a packet transferred from the packet processor 110 based on results searched according to a packet address searching operation and a packet content searching operation. The packet forwarding unit 150 may be configured to revise packet information or discard a packet.

As described above, the packet processing device 100 of the inventive concept may improve a packet processing speed by using the address-based CAM unit 130 and the content-based CAM unit 140. A search capacity may be improved in quality and quantity by using the address-based CAM unit 130 and the content-based CAM unit 140 considering packet address and content. Thus, search flexibility of the packet processing device 100 associated with packet processing may be improved.

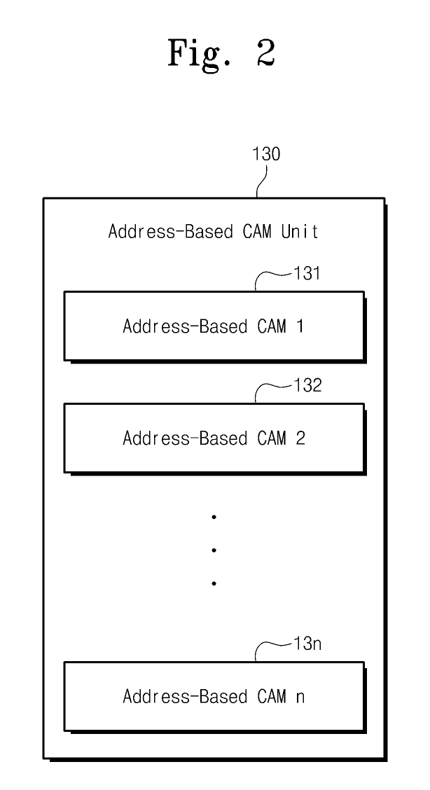

FIG. 2 is a block diagram schematically illustrating an address-based CAM unit according to an embodiment of the inventive concept.

Referring to FIG. 2, an address-based CAM unit 130 may include a plurality of address-based CAMs 131 to 13n.

The plurality of address-based CAMs 131 to 13n may include the same information when a lookup table is extended. In the event that the address-based CAMs 131 to 13n are used to extend a search region, the plurality of address-based CAMs 131 to 13n may perform search operations through different lookup tables. For this reason, the plurality of address-based CAMs 131 to 13n may have different lengths of search keys or different sizes of memories.

For example, when a search key associated with a packet address is provided, the first address-based CAM 131 may search the whole space to output an address matched with a corresponding search key or data corresponding to a search key. The remaining address-based CAMs 132 to 13n may operate the same as the first address-based CAM 131.

For example, it is assumed that an address region of a packet is divided into a region A and a region B. At this time, contents of a table associated with the A region may be stored at the first address-based CAM 131, and contents of a table associated with the B region may be stored at the second address-based CAM 132. At a pre-processing operation, a packet processor 110 may provide a search key capable of Classifying the first address-based CAM 131 and the second address-based CAM 132. Since table and search key sizes of the first address-based CAM 131 are different from table and search key sizes of the second address-based CAM 132, times taken to search may be different. However, plural search keys may be searched at the same time by operating the first and second address-based CAM 131 and 132, independently.

Since the address-based CAMs 131 to 13n process data in parallel, the packet processing performance may be improved.

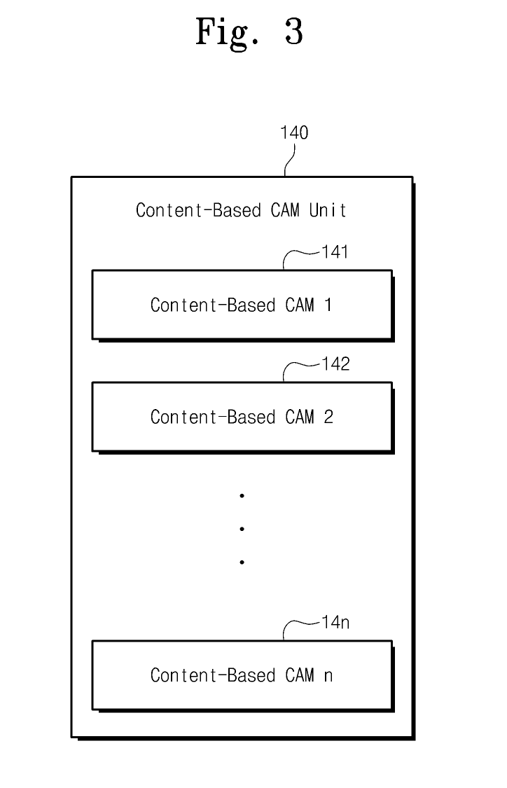

FIG. 3 is a block diagram schematically illustrating a content-based CAM unit according to an embodiment of the inventive concept.

Referring to FIG. 3, a content-based CAM unit 140 may include a plurality of content-based CAMs 141 to 14n.

The plurality of address-based CAMs 141 to 14n may include the same information when a lookup table is extended. In the event that the address-based CAMs 141 to 14n are used to extend a search region, the plurality of address-based CAMs 141 to 14n may perform search operations through different lookup tables. For this reason, the plurality of address-based CAMs 141 to 14n may have different lengths of search keys or different sizes of memories.

For example, when a search key associated with a packet address is provided, the first content-based CAM 141 may search the whole space to output data matched with a corresponding search key. The remaining address-based CAMs 142 to 14n may operate the same as the first content-based CAM 141.

The content-based CAM unit 140 may process data in parallel using the plurality of address-based CAMs 141 to 14n, so that the packet processing performance of the content-based CAM unit 140 is improved.

Packet processing devices of the inventive concept may be applied to an element of a network, for example, a switch, a router, or the like. Since the packet processing devices of the inventive concept may improve the performance of quantity capable of processing increased traffic in real time and the performance of quality capable of providing a specialized service and coping with appearance of a new service.

A packet processing device of the inventive concept may be configured to classify both an address-based packet and a content-based packet in parallel. Thus, it is possible to classify a high-speed packet having four or more layers. That is, it is possible to improve a processing speed of a packet processing device and to provide the flexibility on packet processing. The packet processing device of the inventive concept may enable plural devices capable of performing multi-layer processing to be reduced to one device.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A packet processing device comprising:
a packet processor Classifying a packet according to a region needed to search and providing a search key corresponding to the classified packet;
a search key distributing unit decoding the search key to classify an address-based search key and a content-based search key;
an address-based content addressable memory (hereinafter, referred to as CAM) unit performing an address-based search operation according to the address-based search key;
a content-based CAM unit performing a content-based search operation according to the content-based search key; and
a packet forwarding unit processing an output toward a port corresponding to a packet transferred from the packet processor, based on results searched according to the address-based search operation and the content-based search operation.

2. The packet processing device of claim 1, wherein the packet processor manages a lookup table for providing a search key associated with the packet.

3. The packet processing device of claim 2, wherein the lookup table includes information about a search key for Classifying an address-based packet, a content-based packet, and an address and content-based packet.

4. The packet processing device of claim 3, wherein the search key distributing unit outputs a search key for Classifying the address-based packet to the address-based CAM unit, outputs a search key for Classifying the content-based packet to the content-based CAM unit, and simultaneously outputs a search key for Classifying the address and content-based packet to the address-based CAM unit and the content-based CAM unit.

5. The packet processing device of claim 1, wherein the packet processor performs a matching operation about an address region of the packet based on a stored mask bit region.

6. The packet processing device of claim 5, wherein the packet processor provides the packet forwarding unit with a packet matched with the mask bit region.

7. The packet processing device of claim 6, wherein the packet forwarding unit forwards a packet transferred from the packet processor.

8. The packet processing device of claim 1, wherein the address-based CAM unit includes a plurality of address-based content addressable memories for parallel search processing.

9. The packet processing device of claim 8, wherein sizes and search key bit lengths of the plurality of address-based content addressable memories are set to be different.

10. The packet processing device of claim 8, wherein the plurality of address-based content addressable memories process classified address regions of a packet, respectively.

11. The packet processing device of claim 1, wherein the contents-based CAM unit includes a plurality of content-based content addressable memories for parallel search processing.

12. The packet processing device of claim 11, wherein sizes and search key bit lengths of the plurality of content-based content addressable memories are set to be different.

13. The packet processing device of claim 1, wherein the packet forwarding unit discards the packet when a discard of the packet is needed and revises information of the packet when a revision of the packet is needed.

14. A method of processing a packet comprising:
Classifying a packet according to a region needed to search;
distributing an address-based search key and a content-based search key through decoding of a search key corresponding to the classified packet;
performing search operations on the address-based search key and the content-based search key in parallel; and
outputting the packet according to the search result to be forwarded to a corresponding port.

15. The method of claim 14, wherein the Classifying a packet according to a region needed to search is performed using a lookup table including information about a search key for Classifying an address-based packet, a content-based packet, and an address and content-based packet.

16. The method of claim 15, wherein the performing search operations on the address-based search key and the content-based search key in parallel comprises:
performing a search operation about an address-based search key for Classifying the address-based packet;
performing a search operation about an content-based search key for Classifying the content-based packet; and
simultaneously performing a search operation about an address-based search key for Classifying the address-based packet and a search operation about an content-based search key for Classifying the content-based packet.

17. The method of claim 14, wherein the performing search operations on the address-based search key and the content-based search key in parallel comprises:
performing search operations of the distributed address-based search keys in parallel; and
performing search operations of the distributed content-based search keys in parallel.
